(19) United States
(12) Patent Application Publication
(10) Pub. No.: US 2007/0261096 A1
(43) Pub. Date: Nov. 8, 2007

(54) Apparatus and method for data capture with multi-threshold decision technique

(75) Inventors: Hung-Ming Lin, Hsinchu City (TW); Hung-Ju Huang, Hsinchu City (TW); Ming-Chi Pai, Hsinchu City (TW)

Correspondence Address: John Chen;Room 303, 3F, No 25, Sec. 1, Changan E. Road, Taipei, 10441, TW

(73) Assignee: ASPEED Technology Inc.

(21) Appl. No.: 11/429,200

(22) Filed: May 8, 2006

(51) Int. Cl. H04N 7/173

(52) U.S. Cl. 725/134

(57) ABSTRACT

An apparatus and method for data capture with multi-threshold decision technique is disclosed. An apparatus for data capture with multi-threshold decision technique comprises a capture engine unit being operative to captures data from a video source, a buffer unit being operative to store the captured data by the capture engine unit, and a comparison unit being operative to compare the captured data stored in the buffer unit with a newly captured data outputted from the capture engine unit, wherein the comparison unit utilizes different thresholds to distinguish the difference degree between the captured data stored in the buffer unit and a newly captured data outputted from the capture engine unit so as to determine whether performing data update or not.

### BACKGROUND OF THE PRESENT INVENTION

1. Field of Invention

The present invention relates to the delivery of data through a network, and more particularly to an apparatus and method for data capture with multi-threshold decision technique.

2. Description of Related Arts

As described in U.S. Pub. No. 2006/0020710, the Internet is quite versatile in the types of data and content that can be delivered, as well as in the types of equipment or destinations to which such data and content is delivered. The versatility of the Internet is due in part to the mechanism used for transmitting data. In essence, the Internet allows any type of data or content to be delivered as long as the data or content is packed in data packets in conformance with the TCP/IP protocol requirements. Thus, the Internet can be used for the delivery of content such as data, audio and video.

In the delivery of voice and/or video over the Internet, several technical issues must be confronted. The amount of data that is required to represent an audio or video signal can be quite extensive. When delivering large amounts of data over the Internet, there is an increased probability that data packets containing portions of the audio or video signal can be lost, damaged or delayed. As a result, there can be a significant lag time in the delivery of the content. In addition, the amount of data, especially for video content, that must be transmitted is quite enormous. Thus, significant delays can be incurred in the delivery of the content due to bandwidth constraints.

One method that has been introduced to address these problems is to reduce the quality of the delivered signals. Such a technique would allow the content to be delivered in a more bandwidth efficient manner, however, as the world is migrating towards higher quality (i.e., the introduction of digital radio, DVDs, High-Definition TV, etc.) it may be quite reluctant to adopt such an inferior technology.

Other solutions for providing audio or video over the Internet rely heavily upon the use of buffering. Buffering is a process whereby a receiving machine will request audio or video data and will store a certain amount of time worth of data into a buffer before starting to playback the content. While the stored content is being played back, the computer request the downloading of additional data. The goal is to continually maintain a continuous feed of the audio or video by continually loading the buffer while the content is being played. The problem with this technique is that the playback of the content is not in real-time, it is delayed at least by the amount of time to fill up the buffer initially. In addition, during heavy traffic periods, the buffer may be emptied prior to completely down loading additional data. In this situation, the playback can be choppy or delayed and results in frozen frames.

Another method that has been introduced is the use of data compression. Current state of the art data compression techniques allow for a reduction in the amount of data required to deliver audio and/or video content. However, even using current state-of-the-art data compression techniques, the deliver of real-time video is still subject to significant delays.

However, in the art a method and system have been introduced to utilize a threshold value to determine whether determining the need for transmitting data or not. Therefore, in order to deliver data over the Internet in a bandwidth efficient and real-time manner that alleviates delays due to content delivery or buffering, the present invention provides an apparatus and/or method for data capture with multi-threshold decision technique.

### SUMMARY OF THE PRESENT INVENTION

A main object of the present invention is to provide an apparatus and method for data capture with multi-threshold decision technique in order to deliver data over the Internet in a bandwidth efficient and real-time manner.

Another object of the present invention is to provide an apparatus and method for data capture with multi-threshold decision technique could appropriately transmit data immediately if there is a big change between the newly captured data with the previous data.

Another object of the present invention is to provide an apparatus and method for data capture with multi-threshold decision technique could appropriately transmit data later if the change between the newly captured data with the previous data is small.

Accordingly, in order to accomplish the one or some or all above objects, the present invention provides an apparatus for data capture with multi-threshold decision technique comprising:
a capture engine unit being operative to captures data from a video source;
a buffer unit being operative to store the captured data by the capture engine unit; and
a comparison unit being operative to compare the captured data stored in the buffer unit with a newly captured data outputted from the capture engine unit, wherein the comparison unit utilizes different thresholds to distinguish the difference degree between the captured data stored in the buffer unit and a newly captured data outputted from the capture engine unit so as to determine whether performing data update or not.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1 is a general block diagram of an apparatus for data capture with multi-threshold decision technique according to a preferred embodiment of the present invention.

FIG. 2 is a general block diagram of the comparison unit 130 according to the above-preferred embodiment of the present invention.

### DETAILED DESCRIPTION OF THE PREFERRED EMBODIMENT

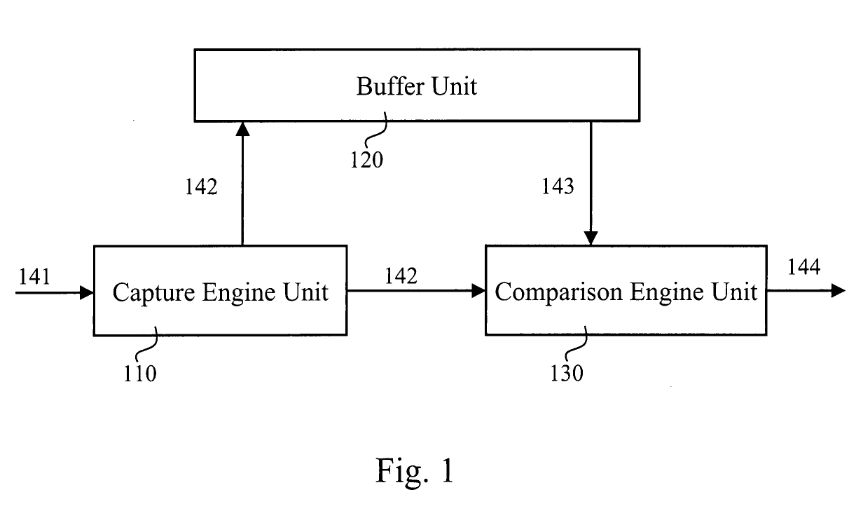

Referring to FIG. 1, a general block diagram of an apparatus for data capture with multi-threshold decision technique according to a preferred embodiment of the present invention is illustrated. As shown in FIG. 1, the apparatus for data capture with multi-threshold decision technique comprises a capture engine unit 110, a buffer unit 120, and a comparison unit 130. The capture engine unit 110 is operative to capture raw data 141. The raw data could be audio data, image data, or video data such as movies, which are based on frames. The raw data also could be an uncompressed analog or digital format. In addition, the raw data could be a single data, a multiple data or a block of data.

The capture engine unit 110 captures a first frame from the video source (raw data 141). The first frame is in an uncompressed digital format. This raw image data is typically a frame constructed as a bitmap, which by definition is made from a matrix of pixels. For purposes of discussion, a pixel can be considered as the basic programmable video unit for a computer display. The specific color of a pixel is some combination of three primary colors—red, green and blue (RGB). It should also be appreciated that a pixel could be a boolean function (i.e., black or white, on or off) or a grey scale value. Generally, a color pixel for an image can be specified using 24 bits with one byte or octet being used to store each color value. The bitmap defines the display space with respect to the upper left corner of the image and defines the color for each pixel. Other techniques can be used to represent pixels and the present invention anticipates the use of such other techniques. For instance, the pixel may include a characteristic component that identifies various attributes of the pixel including color components, shading, brightness, etc. The present invention can be easily adapted to work with any form for defining a pixel.

The capture engine unit 110 outputs the first frame 141 to the buffer unit 120. After the first frame 141 is stored in the buffer unit 120, the capture engine unit 110 captures a next frame (second frame) 142 from the video source. The capture engine unit 110 outputs the next frame 142 to the buffer unit 120 and the comparison unit 130. The next frame 142 is stored in the buffer unit 120. The comparison unit 130 operates to compare each pixel in the base frame 143 with the corresponding pixel in the next frame 142. In other words, the comparison unit 130 compares each pixel from the newly captured frame 143 to the corresponding pixel in the previous frame 143. The comparison unit 130 determines the output 144 according to different criteria and the comparison result.

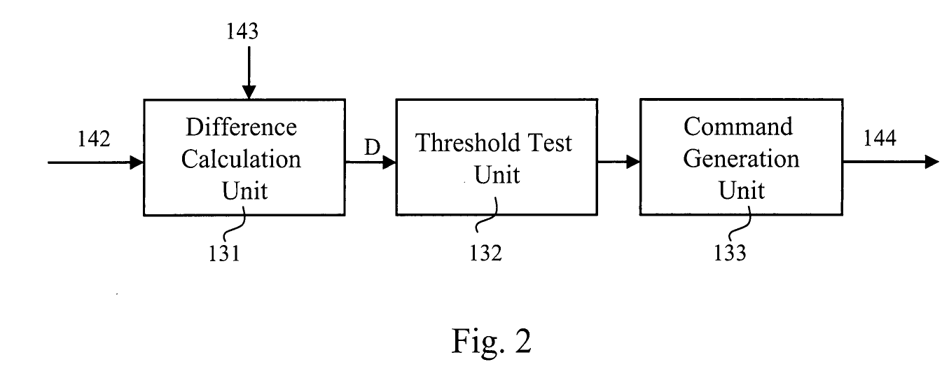

Referring to FIG. 2, a general block diagram of the comparison unit 130 according to the above preferred embodiment of the present invention is illustrated. As shown in FIG. 2, the comparison unit 130 comprises a difference calculation unit 131, a threshold test unit 132, and a command generation unit 133.

The difference calculation unit 131 compares each pixel from the newly captured frame to the corresponding pixel in the previous frame and calculates the difference value between each pixel from the newly captured frame with the corresponding pixel in the previous frame. We use different criteria to illustrate the operation of the comparison unit 130 from the following description. In a simple example, in an implementation with three intermediate thresholds, an overflow threshold W4, an underflow threshold W0, and three intermediate thresholds W1, W2, W3 may be predetermined. For example, the equation for the characteristics of thresholds can be described as below: W0<W1<W2<W3<W4. Once the difference calculation unit 131 calculates the difference value D between each pixel from the newly captured frame to the corresponding pixel in the previous frame and outputs the difference value D to the threshold test unit 132. The threshold test unit 132 will determines the output according to the different criteria and the difference value. In this example, there are three counters C1, C2, C3 for the block. If the difference value D exceeds the overflow threshold W4, it represents that there is a big change between the newly captured frame with the previous frame. Then the threshold test unit 132 outputs a signal to the command generation unit 133. The command generation unit 133 will generates a command to do the data update or the data transmission through the network. If the difference value D exceeds the intermediate threshold W3 but is smaller than the overflow threshold W4, it represents that there is an intermediate change between the newly captured frame with the previous frame. The threshold test unit 132 increases a first predetermined number A1 into the counter C3. After the counter C3 is increased, the counter C3 is compared to a first configurable trigger value (configured value is typically a percentage of pixels in a block). If the counter C3 exceeds or meets the first configurable trigger value, it represents that there is an ultimate change between the newly captured frame with the previous frame. Then the threshold test unit 132 outputs a signal to the command generation unit 133. The command generation unit 133 generates a command to do the data update, the data compression, or the data transmission through the network. At the same time the counters C1, C2, C3 are reset to zero.

Similar to the counter C3, if the difference value D exceeds the intermediate threshold W2 but is smaller than the intermediate threshold W3, it represents that there is an intermediate change between the newly captured frame with the previous frame. The threshold test unit 132 increases a second predetermined number A2 into the counter C2. After the counter C2 is increased, the counter C2 is compared to a second configurable trigger value (configured value is typically a percentage of pixels in a block). If the counter C2 exceeds or meets the second configurable trigger value, it represents that there is an ultimate change between the newly captured frame with the previous frame. Then the threshold test unit 132 outputs a signal to the command generation unit 133. The command generation unit 133 generates a command to do the data update, the data compression, or the data transmission through the network. At the same time the counters C1, C2, C3 are reset to zero.

Similar to the counter C3, if the difference value D exceeds the intermediate threshold W1 but is smaller than the intermediate threshold W2, it represents that there is an intermediate change between the newly captured frame with the previous frame. The threshold test unit 132 increases a second predetermined number A3 into the counter C1. After the counter C1 is increased, the counter C1 is compared to a third configurable trigger value (configured value is typically a percentage of pixels in a block). If the counter C1 exceeds or meets the third configurable trigger value, it represents that there is an ultimate change between the newly captured frame with the previous frame. Then the threshold test unit 132 outputs a signal to the command generation unit 133. The command generation unit 133 generates a command to do the data update, the data compression, or the data transmission through the network. At the same time the counters C1, C2, C3 are reset to zero.

If the difference value D is smaller than the underflow threshold W0, it represents that there is no change between the newly captured frame with the previous frame. The command generation unit 133 will not generate a command to do the data update, the data compression, or the data transmission through the network.

In the above description, we use the difference value between each pixel from the newly captured frame with the corresponding pixel in the previous frame as an index to determine whether the counters C1, C2, C3 should be increased or the data update, the data compression, or the data transmission through the network should be done or not. Actually, the absolute difference value D, the squared difference value D, the sum of the absolute difference value D of the block of data, the sum of the squared difference value D of the block of data, or the maximal absolute difference value D of the block of data also could be the index to determine whether the counters C1, C2, C3 should be increased or the data update, the data compression, or the data transmission through the network should be done or not.

Therefore, the present invention provides an apparatus and method for data capture with multi-threshold decision technique, which could accomplish the noise reduction because of the multi-threshold decision technique. Additionally, the apparatus and method for data capture with multi-threshold decision technique could appropriately transmit data immediately if there is a big change between the newly captured data with the previous data. The apparatus and method for data capture with multi-threshold decision technique could appropriately transmit data later if the change between the newly captured data with the previous data is small. In conclusion, the present invention provides an apparatus and method for data capture with multi-threshold decision technique in order to deliver data over the Internet in a bandwidth efficient and real-time manner.

One skilled in the art will understand that the embodiment of the present invention as shown in the drawings and described above is exemplary only and not intended to be limited.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A method for data capture with multi-threshold decision technique comprising the steps of:
(a) capturing data from a video source;
(b) storing said captured data in a buffer unit; and
(c) comparing said captured data stored in said buffer unit with a newly captured data, wherein different thresholds are utilized to distinguish the difference degree between said captured data stored in said buffer unit and a newly captured data so as to determine whether performing data update or not.

2. The method, as recited in claim 1, wherein (c) step comprises the steps of:
(c1) comparing said captured data stored in said buffer unit to said newly captured data and calculate an index between said newly captured data with said captured data stored in said buffer unit so as to output said index;
(c2) comparing said index to a plurality of thresholds, said plurality of thresholds comprising an underflow threshold, an overflow threshold, and a plurality of intermediate thresholds;
(c3) generating a signal if said index exceeds said overflow threshold or anyone countered numbers are increased to exceed a predetermined trigger value when said index is within a range from said overflow threshold to said underflow threshold; and
(c4) generating a command to do said data update after said signal is received.

3. The method, as recited in claim 2, wherein said index is selected from the group consisting of a difference value between said newly captured data with said captured data, an absolute difference value, a squared difference value, the sum of absolute difference values of a block of data, the sum of squared difference values of said block of data, and a maximal absolute difference value of said block of data.

4. The method, as recited in claim 1, wherein said captured data is selected from the group consisting of audio data, image data, and video data.

5. The method, as recited in claim 3, wherein said captured data is selected from the group consisting of audio data, image data, and video data.

6. An apparatus for data capture with multi-threshold decision technique comprising:
a capture engine unit being operative to captures data from a video source;
a buffer unit being operative to store said captured data by said capture engine unit; and
a comparison unit being operative to compare said captured data stored in said buffer unit with a newly captured data outputted from said capture engine unit, wherein said comparison unit utilizes different thresholds to distinguish the difference degree between said captured data stored in said buffer unit and a newly captured data outputted from said capture engine unit so as to determine whether performing data update or not.

7. The apparatus, as recited in claim 6, wherein said comparison unit comprises:
a difference calculation unit being operative to compare said captured data stored in said buffer unit to said newly captured data and calculate an index between said newly captured data with said captured data stored in said buffer unit so as to output said index;
a threshold test unit being operative to receive said difference value and compare said difference value to a plurality of thresholds, said plurality of thresholds comprising an underflow threshold, an overflow threshold, and a plurality of intermediate thresholds, wherein said threshold test unit comprises corresponding counters with respect to intermediate thresholds in which said threshold test unit outputs a signal if said index exceeds said overflow threshold or anyone of said counters are increased to exceed a predetermined trigger value when said index is within a range from said overflow threshold to said underflow threshold; and
a command generation unit being operative to receive said signal so as to generate a command to do said data update.

8. The apparatus, as recited in claim 7, wherein said index is selected from the group consisting of a difference value between said newly captured data with said captured data, an absolute difference value, a squared difference value, the sum of absolute difference values of a block of data, the sum of squared difference values of said block of data, and a maximal absolute difference value of said block of data.

9. The apparatus, as recited in claim 6, wherein said captured data is selected from the group consisting of audio data, image data, and video data.

10. The apparatus, as recited in claim 8, wherein said captured data is selected from the group consisting of audio data, image data, and video data.
